(19) United States
(12) Patent Application Publication
(10) Pub. No.: US 2003/0223096 A1
(43) Pub. Date: Dec. 4, 2003

(54) Symbol message coders

(75) Inventors: Robert P. Kogod, Arlington, VA (US); Robyn Cushing, New York, NY (US); David Derrick, Calfion, NJ (US); Bernice Kanner, New York, NY (US); Michael Kelley, Brewster, NY (US); Douglas Leeds, New York, NY (US); Robert Moehl, New York, NY (US); Andrew Sernovitz, New York, NY (US); William Zurynetz, Garfield, NJ (US)

Correspondence Address: COVINGTON & BURLING, ATTN: PATENT DOCKETING, 1201 PENNSYLVANIA AVENUE, N.W., WASHINGTON, DC, 20004-2401, US

(73) Assignee: Robert P. Kogod c/o Charles E. Smith Management, Inc., Arlington, VA

(21) Appl. No.: 10/299,021

(22) Filed: Nov. 19, 2002

Related U.S. Application Data
(63) Continuation-in-part of application No. 10/155,725, filed on May 28, 2002.

(51) Int. Cl. G06K 1/00; B41J 1/00; B41B 1/00; B41F 1/00; G06F 15/00

(52) U.S. Cl. 358/1.18

(57) ABSTRACT

The present invention provides a method for generating symbol messages, and particularly symbol messages using symbols for which efforts have been, are being, or will be made to increase their visibility and familiarity. Such symbols may include trademarks, registered trademarks, service marks, registered service marks, and other well-known symbols. Among other things, the present invention provides a method for generating a symbol or logo alphabet (or Logobet™) and a corresponding lexicon or grammar in which each letter corresponds to a recognized proprietary symbol likely to be associated with the respective letter. The present invention also provides apparatuses (e.g., an encoding and transmitting device such as LoGo Girl™ for generating such symbol messages and displays incorporating such symbol messages.

This application is a continuation-in-part of co-pending U.S. patent application Ser. No. 10/155,725, filed May 28, 2002.

### FIELD OF THE INVENTION

The invention relates to symbol messages. More particularly, the invention relates to messages using symbols of increased visibility, familiarity and interest, and methods and apparatuses for creating such symbol messages.

### BACKGROUND OF THE INVENTION

Organizations and individuals generally value symbols, such as trademarks and service marks, associated with themselves and their goods and services. Entities are often eager to increase the visibility and familiarity of their symbols to consumers and often spend millions of dollars to this end. For example, companies spend tens of millions of dollars simply to associate their name or emblem with a professional sports stadium, a college football bowl game, or a particular message or slogan. Methods and apparatuses for creating symbol messages—particularly messages using symbols for which efforts have been, are being, or will be made to increase their visibility, familiarity, and interest—are desirable.

Some entities control businesses, properties, events, apparel, and other outlets useful for increasing the visibility and familiarity of symbols to consumers. For example, cities have roadside welcome signs; event organizers produce and sponsor events; and clothiers have t-shirts and other apparel. Symbol messages associated with or displayed in such outlets are a useful means for increasing the visibility and familiarity of the respective symbols. Such symbol messages also are useful for branding the corresponding outlets, branding an entity in connection with that outlet, and branding an entity as part of a symbol message. Methods and apparatuses for generating such symbol messages are desirable.

It is also recognized that many consumers like puzzles. Every year, consumers purchase many millions of dollars worth of puzzle-related games, books, and other products. Accordingly, there is an opportunity to capitalize on the consumer interest in puzzles and the interest of companies and individuals in increased visibility and familiarity for their symbols.

### SUMMARY OF THE INVENTION

The following features are present in some, but not necessarily all, embodiments of the present invention.

A feature of the present invention is to provide a method for generating a symbol alphabet in which each letter of the alphabet corresponds to a recognized proprietary symbol likely to be associated with the respective letter. Such symbol alphabets may then be used to form a symbol lexicon. FIG. 1A depicts an example of an alphabet of the present invention. FIG. 1A depicts an alphabet 101 and a corresponding symbol alphabet 102. In the embodiment depicted in FIG. 1A, each symbol in symbol alphabet 102 is a corporate logo or trademark. The owner of each registered trademark is identified in the Brief Description of the Drawings. FIG. 1B and FIG. 1C depict messages generated using the logo alphabet, or Logobet™, created in accordance with the present invention.

Another feature of the present invention is to provide a method for generating a symbol message corresponding to a city name, in which each letter (or group of letters) in the name is replaced by a recognized proprietary symbol likely to be associated with the respective letter (or group of letters). FIG. 2A and FIG. 2B depict an example of a display of the present invention. FIG. 2A depicts a t-shirt bearing the message 201 “I LOVE MEMPHIS.” FIG. 2B depicts a t-shirt bearing a display including a symbol message 202 corresponding to the message 201. In the symbol message 202, the words “I” and “MEMPHIS” are replaced by corresponding symbol words 203 and 204 comprising well-known registered trademarks. The owner of each registered trademark is identified in the Brief Description of the Drawings.

More broadly, a feature of the invention is to provide a method for generating a symbol message.

Another feature of the invention is to provide a method for generating a symbol message using symbols for which efforts have been, are being, or will be made to increase their visibility and familiarity. Such symbols may include trademarks, registered trademarks, service marks, registered service marks, and other well-known symbols.

A further feature of the invention is to provide a method for generating a symbol message from a selected message.

A feature of the invention is to provide a method for generating a symbol message from selected characters.

Another feature of the present invention is to provide a method for generating a symbol message from a selected core set of message characters.

A further feature of the invention is to provide a method for generating a grammar comprising symbols.

A feature of the present invention is to provide an apparatus that implements any or all of the methods of the present invention.

A feature of the invention is to provide an apparatus for generating a symbol message using symbols for which efforts have been, are being, or will be made to increase their visibility and familiarity. Such symbols may include trademarks, registered trademarks, service marks, registered service marks and other well-known marks.

A feature of the present invention is to provide a display through the implementation of any or all of the methods of the present invention.

A further feature of the present invention is to provide a display using symbols for which efforts have been, are being, or will be made to increase their visibility and familiarity.

An embodiment of a method of the present invention includes (i) dividing a message into at least one message subset (and optionally at least two message subsets), (ii) associating a symbol with each message subset, and (iii) replacing each message subset with the associated symbol.

An alternative embodiment of a method of the present invention includes (i) dividing a plurality of characters into at least one character subset (and optionally at least two character subsets), (ii) associating a symbol with at least one of the character subsets, and (iii) generating a message comprising the associated symbol.

An alternative embodiment of a method of the present invention includes (i) dividing a core set of message characters into at least one message subset (and optionally at least two message subsets), (ii) displaying each message subset, (iii) associating each message subset with at least one target symbol, (iv) selecting one associated target symbol for each message subset, (v) replacing each message subset with the selected target symbol, and (vi) displaying each selected target symbol.

An alternative embodiment of a method of the present invention includes (i) generating at least one character subset from a set of characters, (ii) generating a set of symbols, (iii) generating, for each character subset, an association with a symbol subset, and (iv) generating a lexicon comprising each association.

An embodiment of an apparatus of the present invention includes (i) an input device configured to receive a message, (ii) a visual display, (iii) a memory device configured to receive and store information, and (iv) a microprocessor in communication with the memory device, the input device, and the visual display. The apparatus is configured to implement, and to permit a user to implement, any or all of the methods of the present invention.

An embodiment of a design or a display of the present invention includes a plurality of symbols corresponding to selected portions of a message.

An embodiment of a design or a display of the present invention includes a plurality of symbols corresponding to selected characters.

Another embodiment of a design or a display of the present invention includes a plurality of symbols corresponding to a selected core set of message characters.

In embodiments of the present invention, the symbols are trademarks, registered trademarks, service marks, registered service marks, well-known marks, or other proprietary symbols.

Additional objects and advantages of the invention are set forth in part in the description which follows, and in part are apparent from the description, or may be learned by practice of the invention. The objects and advantages of the invention may also be realized and attained by means of the instrumentalities and combinations particularly set out in the appended claims.

### BRIEF DESCRIPTION OF THE DRAWINGS

The accompanying drawings, which are incorporated in and constitute part of the specification, illustrate preferred embodiments of the invention, and together with the description, serve to explain the principles of the invention.

FIG. 1A is an example of a lexicon—using a symbol alphabet—generated according to the embodiment depicted in FIG. 3. FIG. 1A depicts the following registered trademarks: a registered trademark symbol 102(a) associated with and owned by American Telephone and Telegraph Co., 550 Madison Avenue, New York, N.Y. 10022; a registered trademark symbol 102(b) associated with and owned by BellSouth Intellectual Property Corp., 824 Market Street, Suite 510, Wilmington, Del. 19801; a registered trademark symbol 102(c) associated with and owned by Coca-Cola Co., One Coca-Cola Plaza, Atlanta, Ga. 30313; a registered trademark symbol 102(d) associated with and owned by Delta Air Lines, Inc., Atlanta Airport, Atlanta, Ga.; a registered trademark symbol 102(e) associated with and owned by Estee Lauder, Inc., 747 5th Avenue, New York, N.Y. 10019; a registered trademark symbol 102(f) associated with Foot Locker and owned by Venator Group Retail, Inc., 112 West 34th Street, New York, N.Y. 10120; a registered trademark symbol 102(g) associated with and owned by General Electric Corp., One River Road, Schenectady, N.Y. 12345; a registered trademark symbol 102(h) associated with and owned by Hilton Hotels Corp., 9336 Civic Center Dr., Beverly Hills, Calif. 90210; a registered trademark symbol 102(i) associated with Infiniti and owned by Nissan Motor Co., Ltd., No.2 Takaracho, Kanagawa-ku, Yokohama-shi, Kanagawa-ken, Japan; a registered trademark symbol 102(j) associated with and owned by J. P. Morgan Chase & Co., 270 Park Avenue, New York, N.Y. 10017; a registered trademark symbol 102(k) associated with Kmart and owned by S. S. Kresge Co., 2727 2nd Avenue, Detroit, Mich. 48232; a registered trademark symbol 102(l) associated with and owned by Lucent Technologies Inc., 600 Mountain Avenue, Murray Hill, N.J. 07974; a registered trademark symbol 102(m) associated with and owned by McDonald's Corp., One McDonald's Plaza, Oak Brook, Ill. 60523; a registered trademark symbol 102(n) associated with and owned by Nike, Inc., One Bowerman Drive, Beaverton, Oreg. 97005; a registered trademark symbol 102(o) associated with Oldsmobile and owned by General Motors Corp., 300 Renaissance Center, P.O. Box 300, Detroit, Mich. 48265; a registered trademark symbol 102(p) associated with and owned by Pepsico, Inc., 700 Anderson Hill Road, Purchase, N.Y. 10577; a registered trademark symbol 102(q) associated with and owned by Qwest Communications International Inc., 555 Seventeenth Street, Suite 1000, Denver, Colo. 80202; a registered trademark symbol 102(r) associated with and owned by Reebok International Limited, Moor Lane Mill, Moor Lane, Lancaster LA1 1GF, ENGLAND; a registered trademark symbol 102(s) associated with and owned by Safeway Stores, Inc., Fourth and Jackson Streets, Oakland, Calif. 94660; a registered trademark symbol 102(t) associated with and owned by Target Brands, Inc., 1000 Nicollett Ave., TPS 1365, Minneapolis, Minn. 55403; a registered trademark symbol 102(u) associated with and owned by United Air Lines, Inc., P.O. Box 66100, Chicago, Ill. 60666; a registered trademark symbol 102(v) associated with and owned by Volkswagen Aktiengesellschaft Co., Wolfsburg, Fed. Rep. Germany; a registered trademark symbol 102(w) associated with and owned by Whirlpool Properties, Inc., 500 Renaissance Drive, Suite 101, St. Joseph, Mich. 49022; a registered trademark symbol 102(x) associated with and owned by Xerox Corp., 800 Long Ridge Road, Stamford, Conn. 06904; a registered trademark symbol 102(y) associated with and owned by National Yellow Pages Service Agency, Inc., 10700 Meridian Avenue North, Suite 201, Seattle, Wash. 98133; and a registered trademark symbol 102(z) associated with and owned by Zenith Electronics Corp., 1000 Milwaukee Avenue, Glenview, Ill. 60025.

FIG. 1B is an example of a symbol message created by using the lexicon depicted in FIG. 1A. The symbol message depicted in FIG. 1B comprises registered trademark symbols 102(a), (e), (f), (g), (i), (l), (n), (o), (r), (s), and (v) of FIG. 1A.

FIG. 1C is another example of a symbol message created by using the lexicon depicted in FIG. 1A. The symbol message depicted in FIG. 1C comprises registered trademark symbols 102(a), (b), (d), (h), (i), (p), (r), (t), and (y) of FIG. 1A.

FIG. 2A and FIG. 2B, respectively, depict an example of a t-shirt bearing a selected message and a t-shirt bearing an embodiment of a display of the present invention corresponding to the selected message. Symbol message 202 in FIG. 2B comprises the following registered trademarks: a registered trademark symbol 203 and 210 associated with Infiniti and owned by Nissan Motor Co., Ltd., No.2 Takaracho, Kanagawa-ku, Yokohama-shi, Kanagawa-ken, Japan; a registered trademark symbol 205 and 207 associated with and owned by Motorola, Inc., 1303 East Algonquin Road, Schaumburg, Ill. 60196; a registered trademark symbol 206 associated with and owned by Estee Lauder, Inc., 747 5th Avenue, New York, N.Y. 10019; a registered trademark symbol 208 associated with and owned by associated with and owned by Pepsico, Inc., 700 Anderson Hill Road, Purchase, N.Y. 10577; a registered trademark symbol 209 associated with and owned by Hilton Hotels Corp., 9336 Civic Center Dr., Beverly Hills, Calif. 90210, and a registered trademark symbol 211 associated with and owned by Sprint Communications Co., 6480 Sprint Parkway, Overland Park, Kans. 66251.

FIG. 3 is a flow chart depicting an embodiment of the present invention in which a lexicon of associations is generated between certain character subsets and certain symbol subsets.

FIG. 4 is a flow chart depicting an embodiment of the present invention in which a message is divided into at least one message subset.

FIG. 5 is an example of a symbol message generated according to the embodiment depicted in FIG. 4. FIG. 5. depicts a registered trademark symbol 505 associated with and owned by Chick-Fil-A, Inc., 535 Central Avenue, Suite 102, Hapeville, Ga. 30054, and a registered trademark symbol 506 associated with and owned by Apple Computer, Inc., 1 Infinite Loop, Cupertino, Calif. 95014. These registered trademark symbols also appear in symbol message 508.

FIG. 6 is a flow chart depicting another embodiment of the present invention in which a plurality of characters is divided into at least one character subset.

FIG. 7 is an example of a symbol message generated according to the embodiment depicted in FIG. 6. FIG. 7 depicts the following registered trademarks: a registered trademark symbol 709 associated with and owned by Nike, Inc., One Bowerman Drive, Beaverton, Oreg. 97005; a registered trademark symbol 710 associated with and owned by Estee Lauder, Inc., 747 5th Avenue, New York, N.Y. 10019; a registered trademark symbol 711 associated with and owned by Weyerhaeuser Co., Tacoma, Wash., 98477; a registered trademark symbol 712 associated with and owned by National Yellow Pages Service Agency, Inc., 10700 Meridian Avenue North, Suite 201, Seattle, Wash. 98133; a registered trademark symbol 713 associated with Oldsmobile and owned by General Motors Corp., 300 Renaissance Center, P.O. Box 300, Detroit, Mich. 48265; a registered trademark symbol 714 associated with and owned by Reebok International Limited, Moor Lane Mill, Moor Lane, Lancaster LA1 1GF, ENGLAND; and a registered trademark symbol 715 associated with Kmart and owned by S. S. Kresge Co., 2727 2nd Avenue, Detroit, Mich. 48232. These registered trademark symbols also appear in symbol message 716.

FIG. 8 is a flow chart depicting yet another embodiment of the present invention in which a core set of message characters is divided into at least one message subset.

FIG. 9 is an example of a symbol message generated according to the embodiment depicted in FIG. 8. FIG. 9 depicts the following registered trademarks: a registered trademark symbol 910 and 914 associated with and owned by Mercedes-Benz Aktiengesellschaft, 136 Mercedes Strasse, 7000 Stuttgart 60 (Unterturkheim), Fed. Rep. Germany; a registered trademark symbol 911 and 915 associated with and owned by McDonald's Corp., One McDonald's Plaza, Oak Brook, Ill. 60523; a registered trademark symbol 912 and 916 associated with and owned by Motorola, Inc., 1303 East Algonquin Road, Schaumburg, Ill. 60196; a registered trademark symbol 913 associated with and owned by Estee Lauder, Inc., 747 5th Avenue, New York, N.Y. 10019; a registered trademark symbol 917 associated with and owned by Pepsico, Inc., 700 Anderson Hill Road, Purchase, N.Y. 10577; a registered trademark symbol 918 associated with and owned by Hilton Hotels Corp., 9336 Civic Center Dr., Beverly Hills, Calif. 90210; a registered trademark symbol 919 associated with Infiniti and owned by Nissan Motor Co., Ltd., No.2 Takaracho, Kanagawa-ku, Yokohama-shi, Kanagawa-ken, Japan; and a registered trademark symbol 920 associated with and owned by Sprint Communications Co., 6480 Sprint Parkway, Overland Park, Kans. 66251. These registered trademark symbols, with the exception of registered trademark symbol 910 and 914 associated with and owned by Mercedes-Benz Aktiengesellschaft, also appear in symbol message 924.

FIG. 10 is a diagram depicting embodiments of an apparatus for generating symbol messages, grammars or lexicons according to the present invention.

FIG. 11 is a diagram depicting an embodiment of an apparatus according to the present invention. FIG. 11 depicts the following registered trademarks: a registered trademark symbol associated with Lexus and owned by Toyota Jidosha Kabushiki Kaisha, 1, Toyota-cho, Toyotashi, Aichi-ken, Japan; a registered trademark symbol associated with and owned by Enterprise Rent-A-Car Company, 8850 Ladue Road, St. Louis, Mo. 63124; a registered trademark symbol associated with and owned by Texaco Inc., 2000 Winchester Avenue, White Plains, N.Y. 10650; a registered trademark symbol associated with and owned by a registered trademark symbol associated with and owned by Toyota Jidosha Kabushiki Kaisha, 1, Toyota-cho, Toyota-shi, Aichi-ken, Japan; a registered trademark symbol associated with and owned by Hilton Hotels Corp., 9336 Civic Center Dr., Beverly Hills, Calif. 90210; a registered trademark symbol associated with and owned by E! Entertainment Television, Inc., 5750 Wilshire Boulevard, 4th Floor, Los Angeles, Calif. 90036-3209; a registered trademark symbol associated with and owned by Intel Corporation, 2200 Mission College Boulevard, Santa Clara, Calif. 95052; a registered trademark symbol associated with and owned by Delta Air Lines, Inc., Atlanta Airport, Atlanta, Ga.; a registered trademark symbol associated with and owned by Apple Computer, Inc., 1 Infinite Loop, Cupertino, Calif. 95014; a registered trademark symbol associated with and owned by Shell Oil Company, One Shell Plaza, P.O. Box 2463, Houston, Tex. 77252-2463; a registered trademark symbol associated with BMW and owned by Bayerische Motoren Werke Aktiengesellschaft, Petuelring 130, BMW Haus, Postfach 40-20-40, Munchen, D-80788, Fed Rep Germany; a registered trademark symbol associated with Ericsson and owned by Telefonaktiebolaget LM, Ericsson Corp., S-126 25, Stockholm, Sweden; a registered trademark symbol associated with and owned by Gateway, Inc., 4545 Towne Centre Court, San Diego, Calif. 92121; and a registered trademark symbol associated with and owned by Nike, Inc., One Bowerman Drive, Beaverton, Oreg. 97005.

### DETAILED DESCRIPTION

Visual messages generally are composed of one or more characters or symbols. The characters or symbols may include alphanumeric characters, phonemes, ideographs, pictographs, hieroglyphs, and other forms of visual communication.

The present invention generates visual messages using symbols or symbol alphabets. In some embodiments, the symbols are trademarks, registered trademarks, service marks, registered service marks, well-known marks or symbols, logos or other proprietary symbols. As used in this specification, a well-known mark or symbol is one whose meaning or association is understood or recognized by a segment of the public. A well-known mark includes, but is not limited to, famous trademarks that may be protected under anti-dilution laws. For purposes of this specification, a well-known mark or symbol includes, as another example, marks or symbols that have acquired secondary meaning in a geographic area.

The symbol messages or symbol alphabets according to the present invention—when comprising logos or other similar well-known marks or symbols—are useful for, among other things, increasing the visibility and familiarity of the incorporated symbols. They also are useful for branding the corresponding outlets, branding an entity in connection with that outlet, and branding an entity as part of a symbol message. Such symbol messages or symbol alphabets may be displayed on or in, for example, billboards, print or electronic media, clothing, accessories, or novelty items.

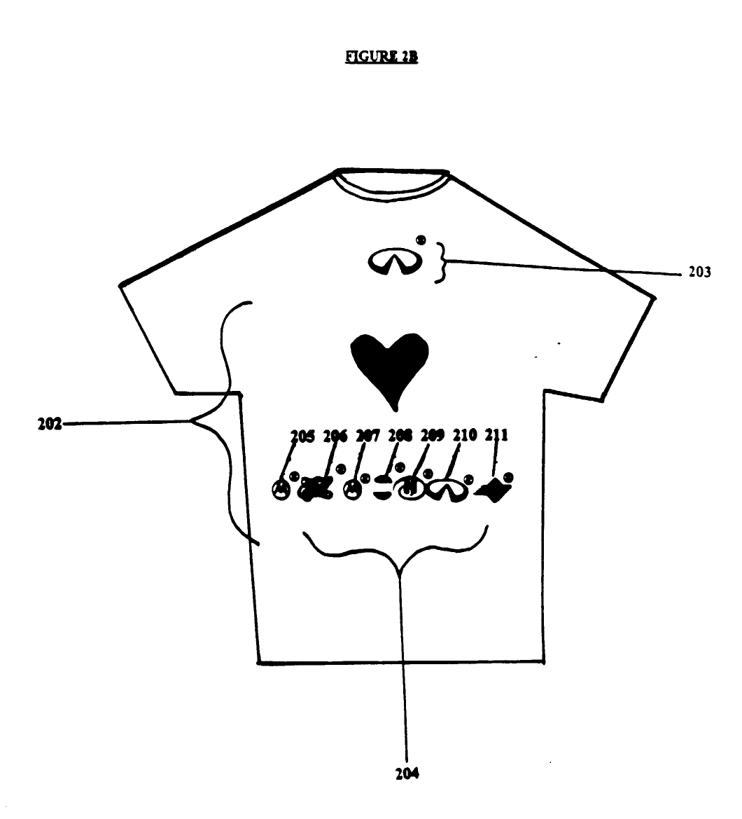

FIG. 3 depicts a flow chart of an embodiment of the present invention. The embodiment depicted in FIG. 3 comprises four steps for generating a grammar comprising symbols:

Generate At Least One Character Subset From A Set Of Characters step 301;

Generate A Set of Symbols step 302;

Generate Associations Between Each Character Subset And A Symbol Subset Of The Set Of Symbols step 303; and

Generate A Lexicon Comprising The Associations step 304.

Steps 301 and 302, respectively, comprise generating at least one character subset from a set of characters and generating a set of symbols. The set of characters comprises characters from existing grammars. For example, the set of characters might be the English alphabet and related phonemes, Egyptian hieroglyphs, or Arabic numerals. The set of symbols might be all trademarks, registered trademarks, service marks, registered service marks, or well-known marks.

Step 303 of the embodiment depicted in FIG. 3 involves generating associations between each character subset and symbol subsets of the set of symbols. The associations preferably are made according to existing relationships—such as visual similarities, phonetic similarities, common initial sounds or characters, or common target audience associations—between the characters and the symbols as described in this specification or as is apparent in view of this specification to one of skill in the art. For example, a character subset may comprise letters from the English alphabet, and symbol subsets may comprise professional sports team emblems. Each team emblem may be associated with the letter corresponding to the first letter of the team name.

In the embodiment depicted in FIG. 3, step 304 follows step 303. Step 304 comprises generating a lexicon using the associations generated in step 303. For example, words and phrases may be generated by replacing each letter with the symbol associated with that letter.

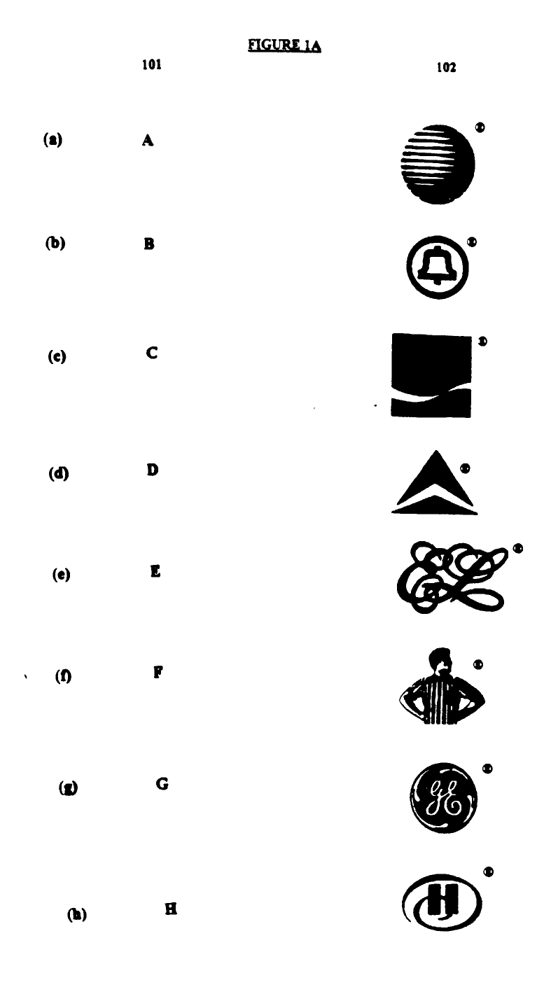

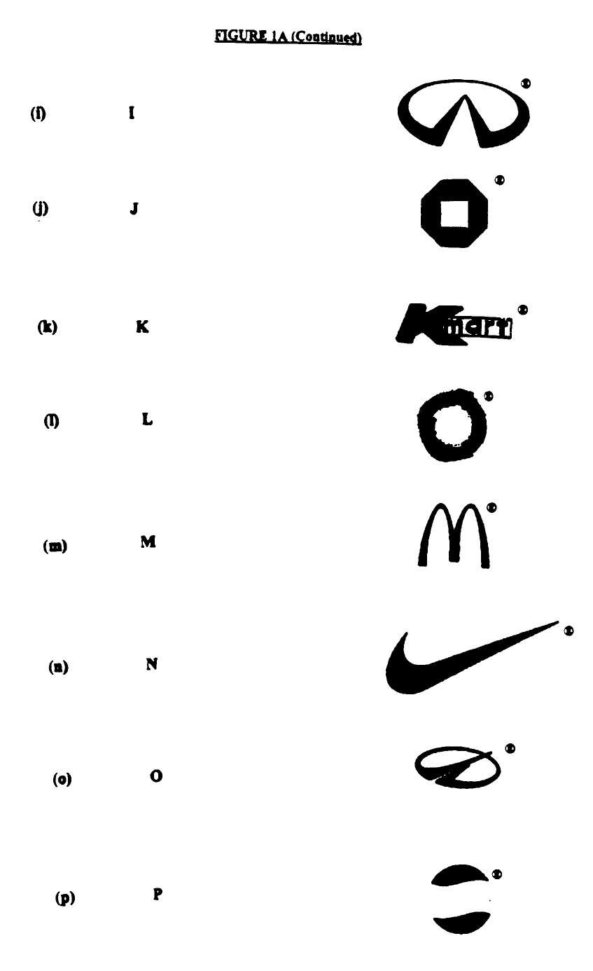

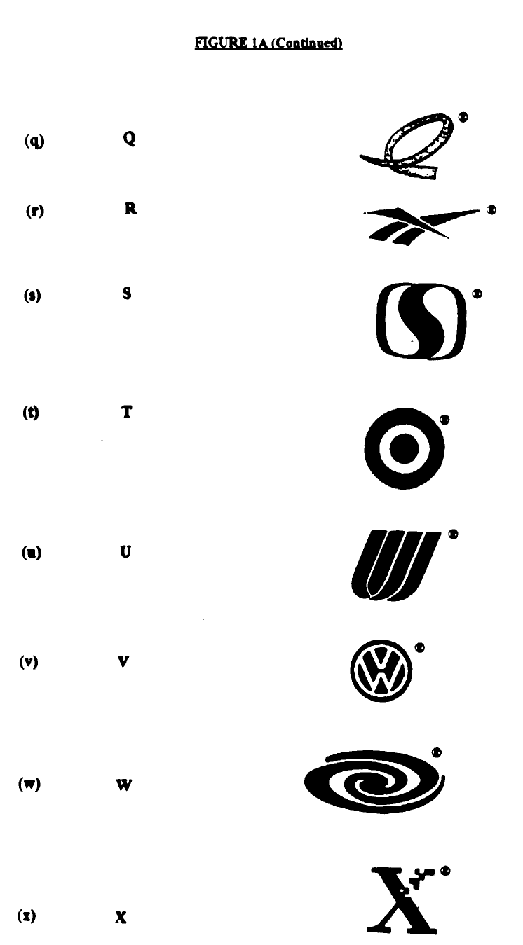

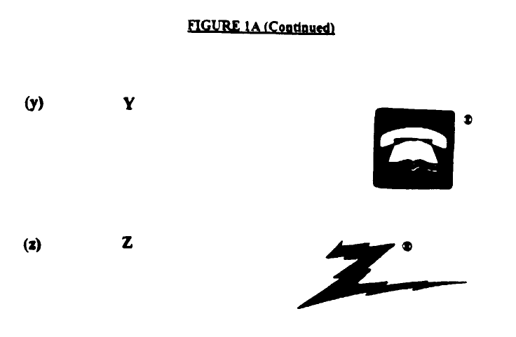

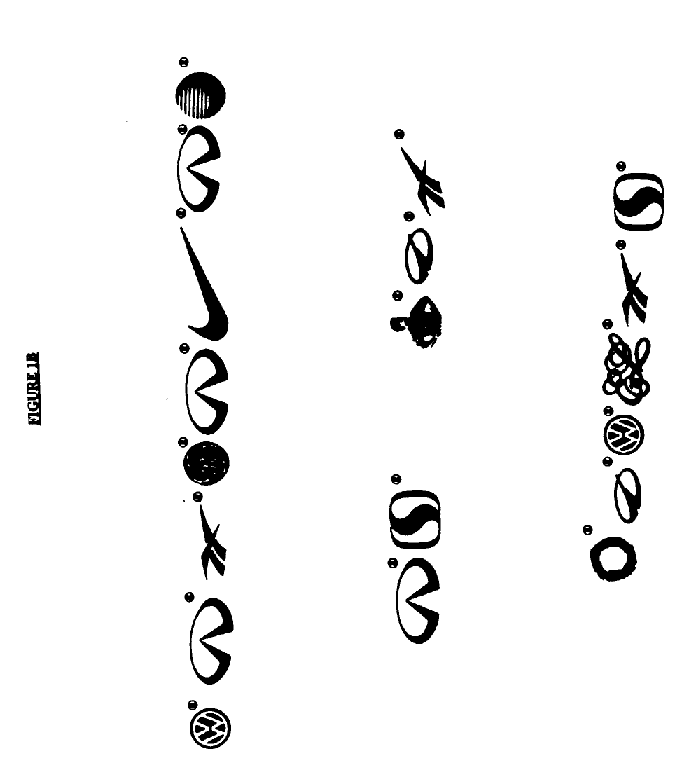

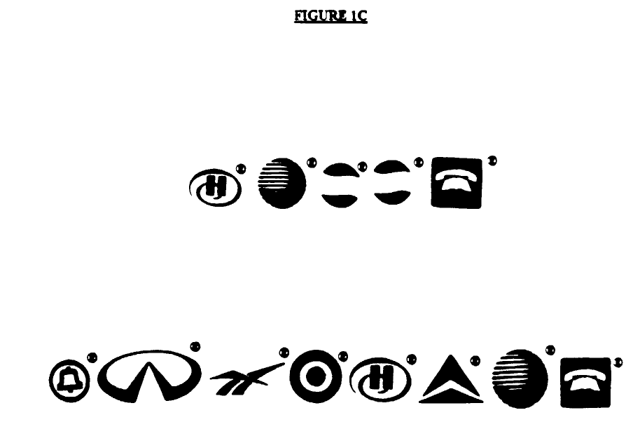

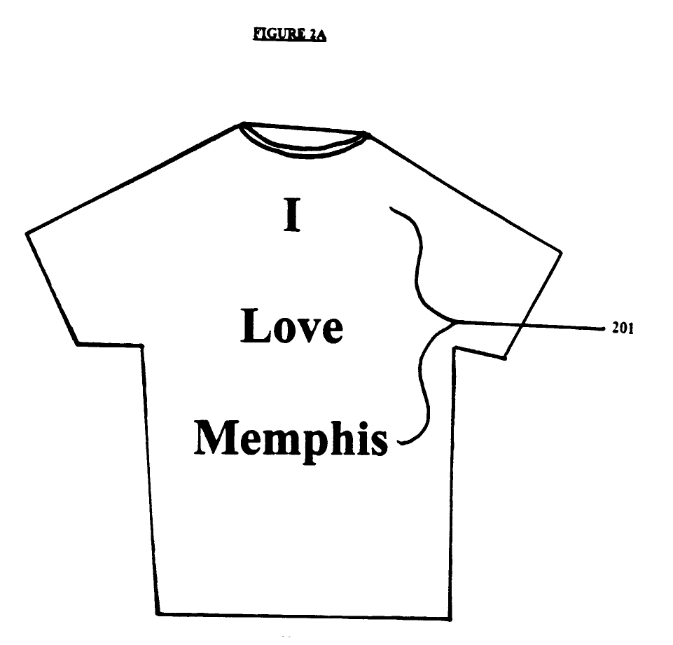

FIG. 1A depicts an example of a lexicon of the present invention, which lexicon was created using the embodiment of FIG. 3. FIG. 1A shows a set of characters 101 and a set of symbols 102 that have been generated. In this example, the character subset comprises the set of characters of the English alphabet, and the symbol associated with each character is a registered trademark. The associations between the two subsets are shown by designations (a) through (z). In this embodiment, these associations generate a symbol alphabet, which are used to generate a lexicon. For example, FIG. 1B shows a symbol message corresponding to the slogan “VIRGINIA IS FOR LOVERS”@, and FIG. 1C shows a symbol message corresponding to the phrase “HAPPY BIRTHDAY.” In other embodiments (not depicted), the characters may include words, phonemes, ideographs or other visual marks or depictions; the symbols may include service marks or other well-known symbols, marks or depictions; and there may be more than one symbol associated with one or more of the character subsets.

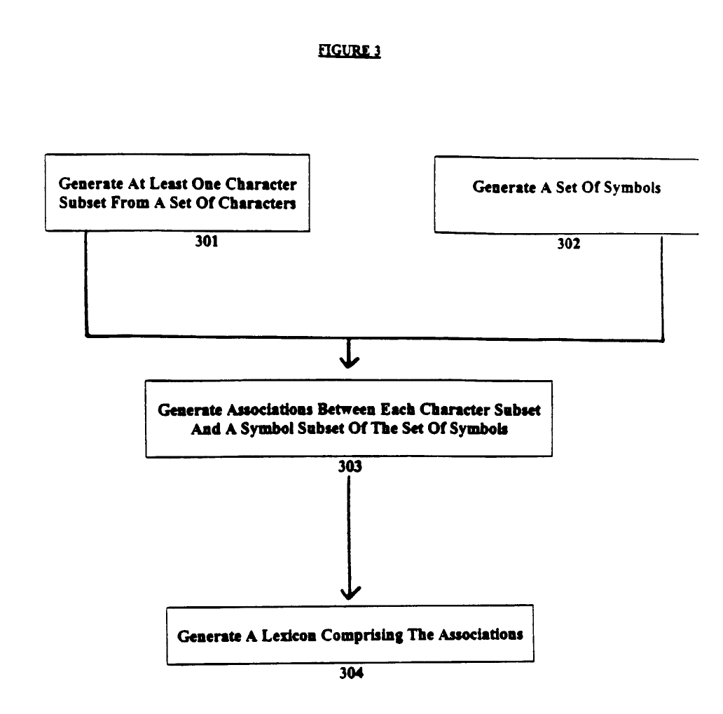

FIG. 4 depicts a flow chart of an embodiment of a method of the present invention. This embodiment comprises three steps for generating a symbol message from a selected message:

Divide The Message Into At Least One Message Subset step 401;

Associate A Symbol With Each Message Subset step 402; and

Replace Each Message Subset With The Associated Symbol step 403.

Step 401 comprises dividing a selected message into one or more message subsets. A message subset may comprise the entire message or some smaller portion of the message (for example, a syllable). If more than one message subset is formed, the message subsets may be the same or different in size. For example, if the message is a word, certain message subsets may include a syllable, and other message subsets may include only a letter.

Step 402 of the embodiment depicted in FIG. 4 comprises associating a symbol with each message subset. In other words, in the embodiment depicted in FIG. 4, each message subset is assigned a symbol. The symbols preferably are trademarks, registered trademarks, service marks, registered service marks, well-known marks, or other proprietary symbols. These symbols optionally are associated with message subsets based on existing or apparent relationships or associations—such as visual similarities, phonetic similarities, common initial characters or sounds, or common target audience associations—between each message subset and each corresponding symbol. For example, if the message is a word and if the word is divided into its letters in step 401, each letter may be assigned a symbol that the target audience associates with a company name beginning with the same letter. Moreover, the same symbol preferably is associated with each message subset having the same value. Thus, in some embodiments, the same letters in a word may be assigned the same symbols.

Step 402 may be implemented before or after step 401. For example, one may first associate symbols with a variety of possible message subsets for a variety of possible messages and then divide the selected message into message subsets that have already been associated with symbols. Alternatively, one may select a message, divide that message into message subsets, and then associate symbols with those message subsets.

Step 403 of the embodiment depicted in FIG. 4 comprises replacing each message subset with the associated symbol. Step 403 follows steps 401 and 402 and converts the selected message to a corresponding symbol message by replacing part or all of the message with symbols.

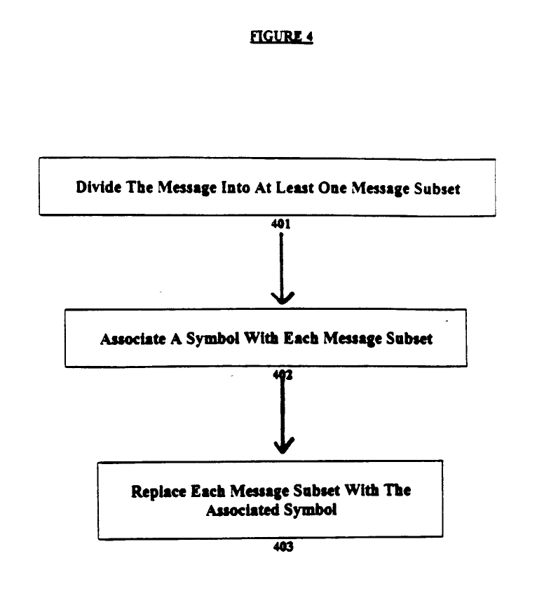

FIG. 5 depicts an example of the embodiment of the present invention depicted in FIG. 4. In this example, the message 501 is the word “CHICAGO.” This message is divided into three message subsets 502, 503, and 504: “CHIC,” “A,” and “GO.” According to step 502 depicted in FIG. 4, each message subset is then associated with a respective symbol 505, 506 and 507. “CHIC” 502 is associated with a registered trademark symbol 505 associated with Chick-Fil-A, Inc. “A” 503 is associated with a registered trademark symbol 506 associated with Apple Computer, Inc. “GO” 504 is associated with a stoplight symbol 507 with the green light turned on. Then each message subset 502, 503, and 504 is replaced with its respective associated symbol 505, 506 and 507, thus yielding the final symbol message 508.

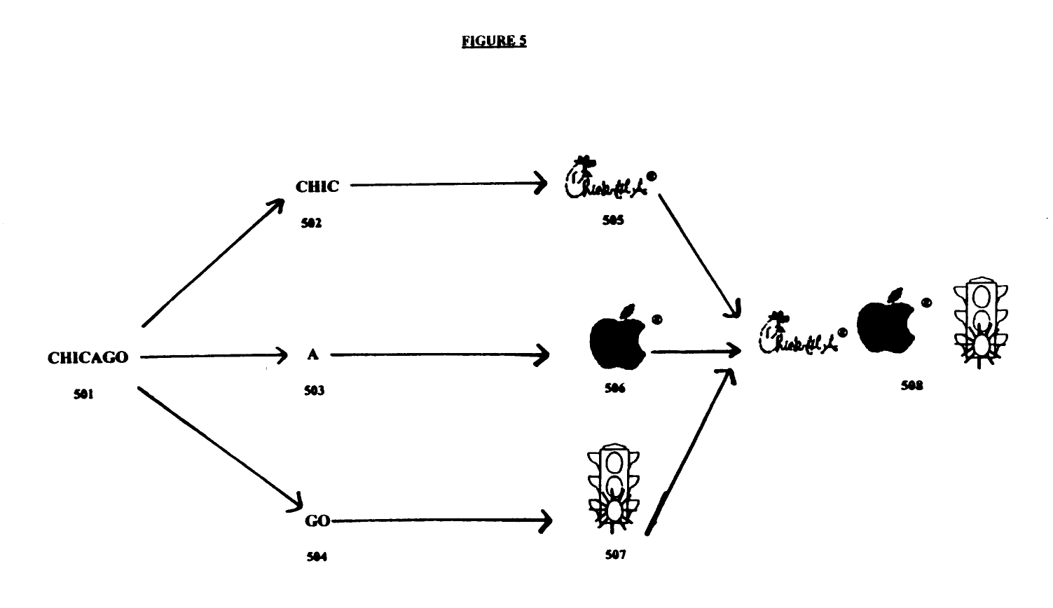

FIG. 6 depicts a flow chart of another embodiment of a method of the present invention. The embodiment depicted in FIG. 6 comprises three steps for generating a symbol message from a selected plurality of characters:

Divide A Plurality of Characters Into At Least One Character Subset step 601;

Associate A Symbol With Each Of The Character Subsets step 602; and

Generate A Message Comprising Each Associated Symbol step 603.

Step 601 comprises dividing a plurality of characters into one or more character subsets. Each character subset may be one or more alphanumeric characters, phonemes, words, ideographs, or any other visual mark or symbol. For example, a plurality of characters could be a name, and that name could be divided into character subsets, with some subsets including a letter and other subsets including a phoneme. As another example, the plurality of characters could be an abbreviation.

Step 602 of the embodiment depicted in FIG. 6 comprises associating a symbol with each of the character subsets. For example, each letter in a name may be assigned one or more symbols which a target audience might associate with that letter. In another example, each ideograph in a Chinese text (the plurality of characters) could be associated with a registered trademark with visual similarity to the ideograph. In step 602, symbols may be associated with character subsets based on existing or apparent relationships or associations—such as visual similarities, phonetic similarities, common initial characters or sounds, or common target audience associations—between each character subset and each corresponding symbol.

Step 602 may be implemented before or after step 601. For example, one may first assign symbols to a range of potential character subsets. One may then divide the selected plurality of characters into character subsets to which symbols already have been assigned. Alternatively one may select a plurality of characters, then divide it into character subsets, and then assign symbols to the character subsets.

Step 603 of the preferred embodiment depicted in FIG. 6 comprises generating a message comprising the symbols associated with each of the character subsets. Step 603 follows steps 601 and 602 and converts the plurality of characters into a corresponding symbol message. The associated symbols are substituted for the corresponding character subsets, thus yielding a symbol message.

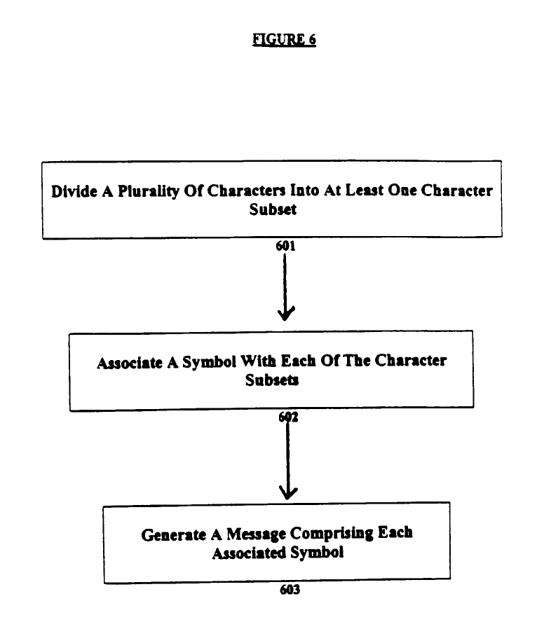

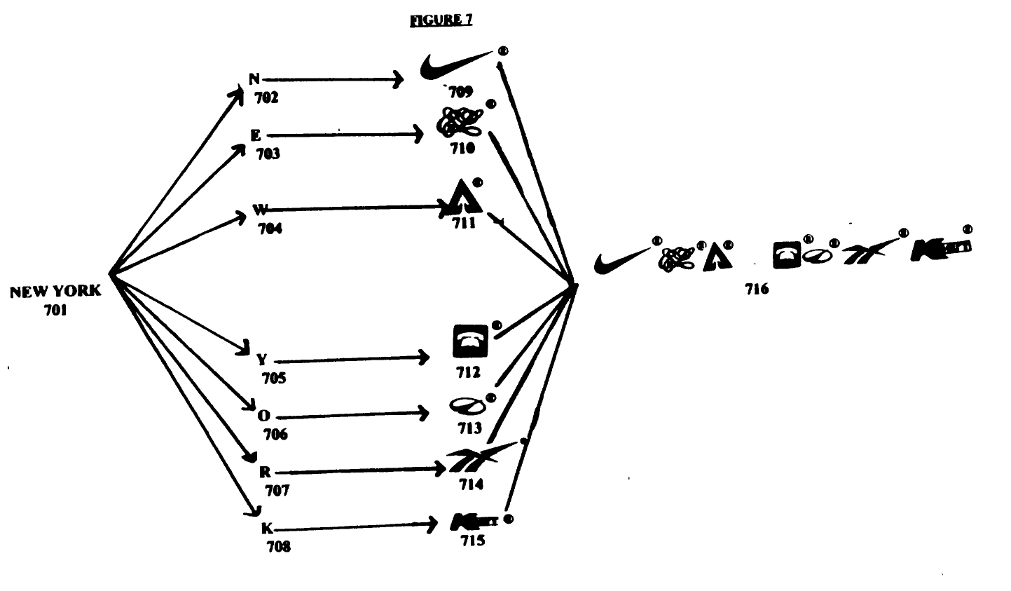

FIG. 7 depicts an example of the embodiment depicted in FIG. 6. In the example depicted in FIG. 7, the plurality of characters 701 is “NEW YORK.” The plurality of characters 701 is divided into seven character subsets 702, 703, 704, 705, 706, 707, and 708: “N,” “E,” “W,” “Y,” “O,” “R,” and “K,” respectively. Each character subset 702, 703, 704, 705, 706, 707 and 708 is associated with a respective symbol 709, 710, 711, 712, 713, 714 and 715. In this example, each of the symbols are registered trademarks, and the character subsets and symbols are associated because the first letter of the brand name consumers associate with each symbol is the same as the corresponding character subset. Other types of associations are described in this specification and would be apparent to one of skill in the art in view of this specification. As depicted in FIG. 7, the symbol message 716 is generated by combining, in order, the associated symbols 709, 710, 711, 712, 713, 714 and 715.

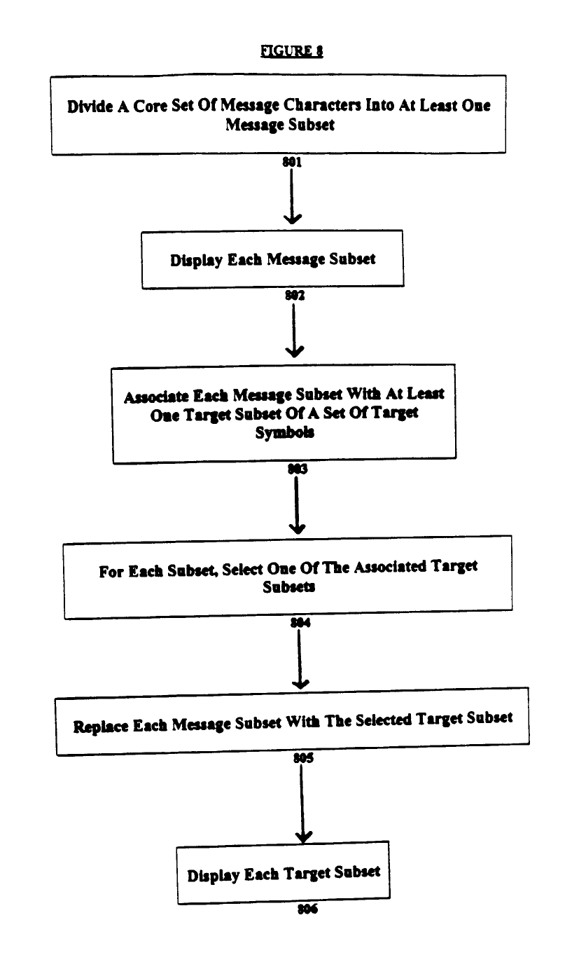

FIG. 8 depicts a flow chart of another embodiment of the method of the present invention. The embodiment depicted in FIG. 8 comprises six steps for generating a symbol message:

Divide A Core Set Of Message Characters Into At Least One Message Subset step 801;

Display Each Message Subset step 802;

Associate Each Message Subset With At least One Target Subset Of A Set of Target Symbols step 803;

For Each Subset, Select One Of The Associated Target Subsets step 804;

Replace Each Message Subset With The Selected Target Subset step 805; and

Display Each Selected Target Subset step 806.

Step 801 comprises dividing a core set of message characters into at least one message subset. The core set of message characters may be all or part of a message, and each message subset may be all or part of the core set of message characters. For example, if a message is a sentence, the core set of message characters might be a word or a phrase of the sentence, or the entire sentence. If the core set of message characters is a word, a message subset might be a letter, a group of letters, a syllable, or the entire word. The message characters and message subsets may comprise alphanumeric characters, phonemes, words, ideographs, or any other visual mark.

Step 802 of the embodiment depicted in FIG. 8 occurs after step 801 and involves displaying each resulting message subset. Display of each message subset shows and confirms how the core set of message characters has been divided.

Step 803 associates each message subset with at least one target subset of a set of target symbols. For example, if a message subset is a phoneme, one or more target symbols associated by a target audience with company names beginning with the same phonetic sound as the phoneme might be associated with the message subset. The set of target symbols may be a closed set, or it may be an open set, for example, all registered trademarks. Step 803 may be implemented before or after either or both of steps 801 and 802. Other ways to generate message subsets and target subsets of target symbols, and to associate message subsets with target subsets, are described in this specification and would be apparent to one of skill in the art in view of this specification.

Step 804 follows, or occurs at the same time as, step 803. Step 804 involves selecting one corresponding target subset for each message subset. For example, if five symbols are associated with one message subset, one of those five symbols would be selected to replace the corresponding message subset.

Step 805 follows steps 801 through 804 and comprises replacing each message subset with the target subset selected for the message subset in step 804. Step 805 converts the core set of message characters into a corresponding symbol message core.

Step 806 follows step 805 and involves the display of each selected target subset. Step 806 may involve the display of one associated target subset for each message subset, or it may involve the display of all associated target subsets for each message subset.

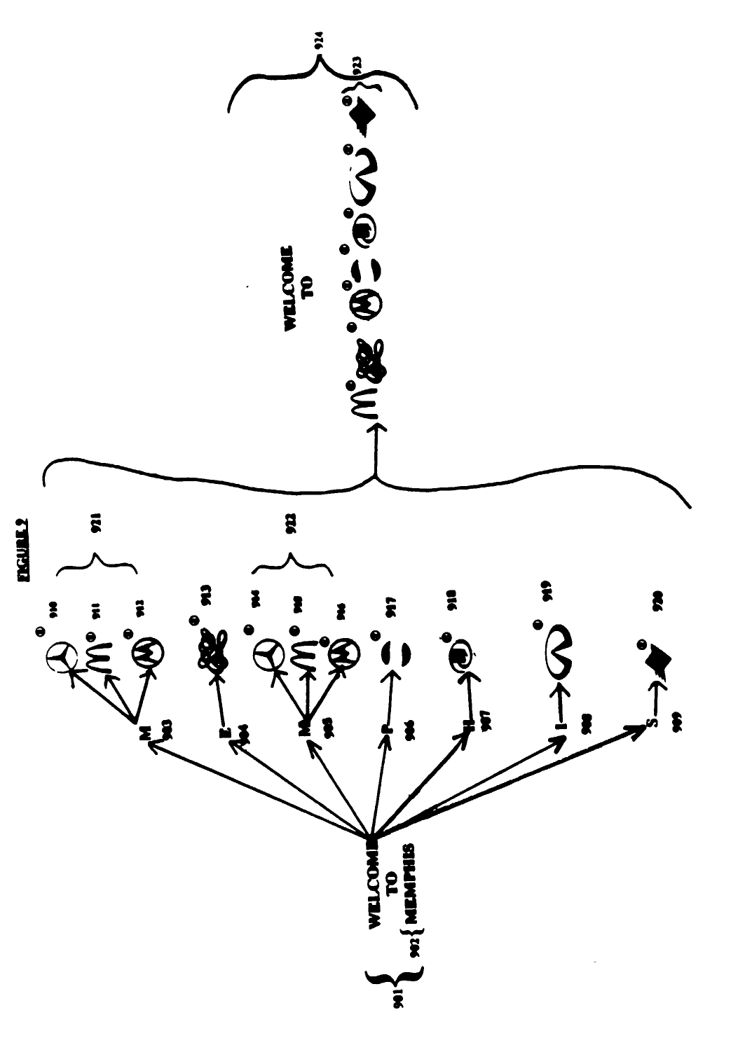

FIG. 9 depicts an example of the embodiment depicted in FIG. 6. The message 901 in this example is “WELCOME TO MEMPHIS.” The core set of message characters 902 in this example is “MEMPHIS.” The core set of message characters 902 is divided into message subsets 903, 904, 905, 906, 907, 908, and 909: “M,” “E,” “M,” “P,” “H,” “I,” and “S,” and each message subset is displayed.

As depicted in FIG. 9, message subset 903 is associated with a target subset 921 including target symbols 910, 911 and 912; message subset 904 is associated with a target subset 913 including target symbol 913; message subset 905 is associated with target subset 922 including target symbols 914, 915 and 916; message subset 906 is associated with target subset 917 including target symbol 917; message subset 907 is associated with target subset 918 including target symbol 918; message subset 908 is associated with target 919 including target symbol 919; and message subset 909 is associated with target 920 including target symbol 920. The target subsets depicted in FIG. 9 were drawn from an open-ended target set of symbols comprising all proprietary symbols. In this example, all of the target symbols are registered trademarks. Target symbols 911, 913, 916, 917, 918, 919, and 920 are then selected, one from each respective target subset 921, 913, 922, 917, 918, 919, and 920, to correspond respectively to each message subset 903, 904, 905, 906, 907, 908, and 909. Each message subset 903, 904, 905, 906, 907, 908, and 909 is then replaced with the corresponding selected target subset, and result 923 is displayed. In the embodiment depicted in FIG. 9, the final symbol message 924 is also displayed.

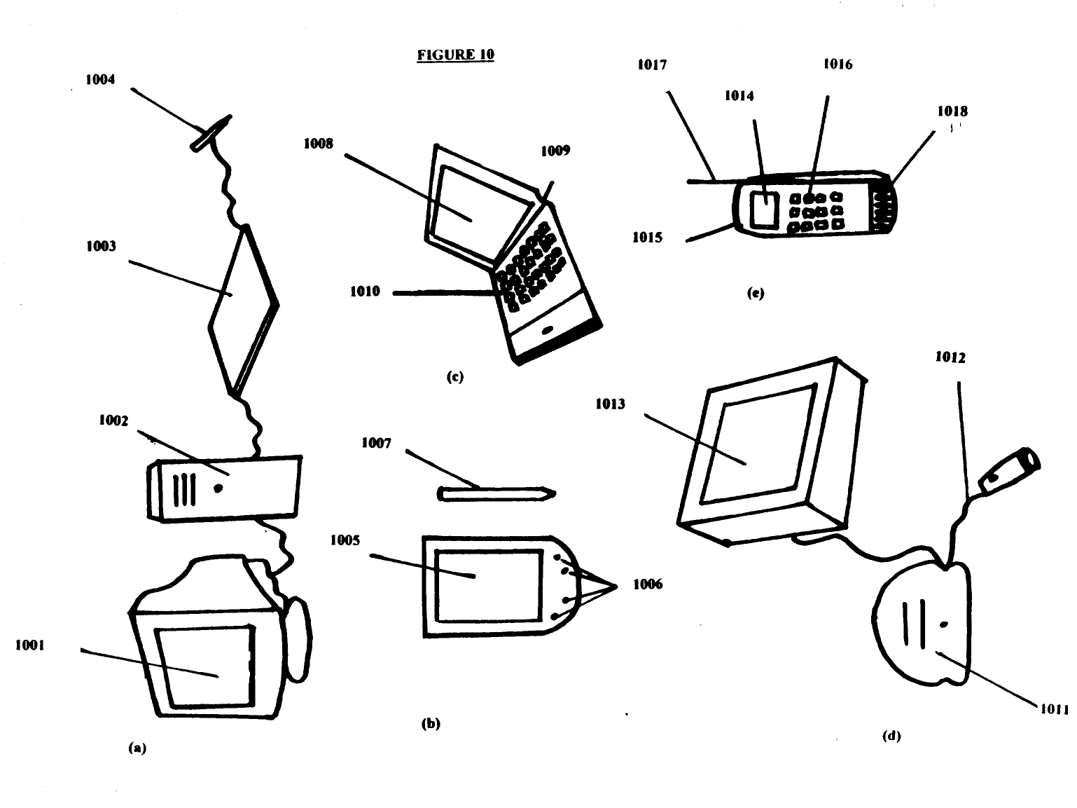

Other embodiments of the present invention include apparatuses configured for generating symbol messages or grammars according to the present invention. FIG. 10 depicts five alternative embodiments. In each embodiment depicted in FIG. 10, the apparatus comprises an input device configured to receive a message, a visual display, a memory device configured to receive and store information, and a microprocessor in communication with the memory device, the input device, and the visual display.

In the embodiment depicted in FIG. 10(a), an example of a desktop computer, the input device is stylus 1004 and pad 1003 for handwriting and drawing recognition and entry; the visual display is monitor 1001; and tower 1002 houses a microprocessor and a memory, which are in communication with each other and pad 1003 and monitor 1001.

In the embodiment depicted in FIG. 10(b), an example of a personal digital assistant, the input device comprises screen display 1005, buttons 1006 and stylus 1007; the visual display is screen display 1005; and the personal digital assistant houses a microprocessor and a memory, which are in communication with each other and buttons 1006 and screen display 1005.

In the embodiment depicted in FIG. 10(c), an example of a laptop computer, the input device is keyboard 1010; the visual display is screen 1008; and laptop 1009 houses a microprocessor and a memory, which are in communication with each other and keyboard 1010 and screen 1008.

In the embodiment depicted in FIG. 10(d), another example of a desktop computer, the input device is microphone 1012; the visual display is screen 1013; and chassis 1011 houses a microprocessor (including voice recognition and generation hardware and software) and a memory, which are in communication with each other and microphone 1012 and screen 1013.

In the embodiment depicted in FIG. 10(e), an example of a wireless telephone, the input devices are keypad 1016, microphone 1018, and receiver/antenna 1017; the visual display is screen 1014; and the wireless telephone 1015 houses a microprocessor and a memory, which are in communication with each other and keypad 1016, microphone 1018, receiver/antenna 1017, and screen display 1014.

In an embodiment, the apparatus according to the present invention is configured to divide a message into at least one message subset, to associate symbols (optionally symbols that are trademarks, registered trademarks, service marks, registered service marks, or well-known marks) with each message subset, and to replace each message subset with the associated symbols.

In an alternative embodiment, the apparatus according to the present invention is configured to divide a plurality of characters into at least one character subset, to associate symbols with each character subset, and to generate messages comprising the associated symbols.

In another embodiment, the apparatus according to the present invention is configured to divide a core set of message characters into at least one message subset, to associate each message subset with at least one target symbol, to prompt the selection of one of the associated target symbols for each message subset, to replace each message subset with the selected target symbol, and to show each message subset and each selected target symbol.

In another embodiment, the apparatus according to the present invention is configured to draw from a set of symbols, to generate an association between subsets of a set of characters and subsets of the set of symbols, and to generate a lexicon comprising such associations.

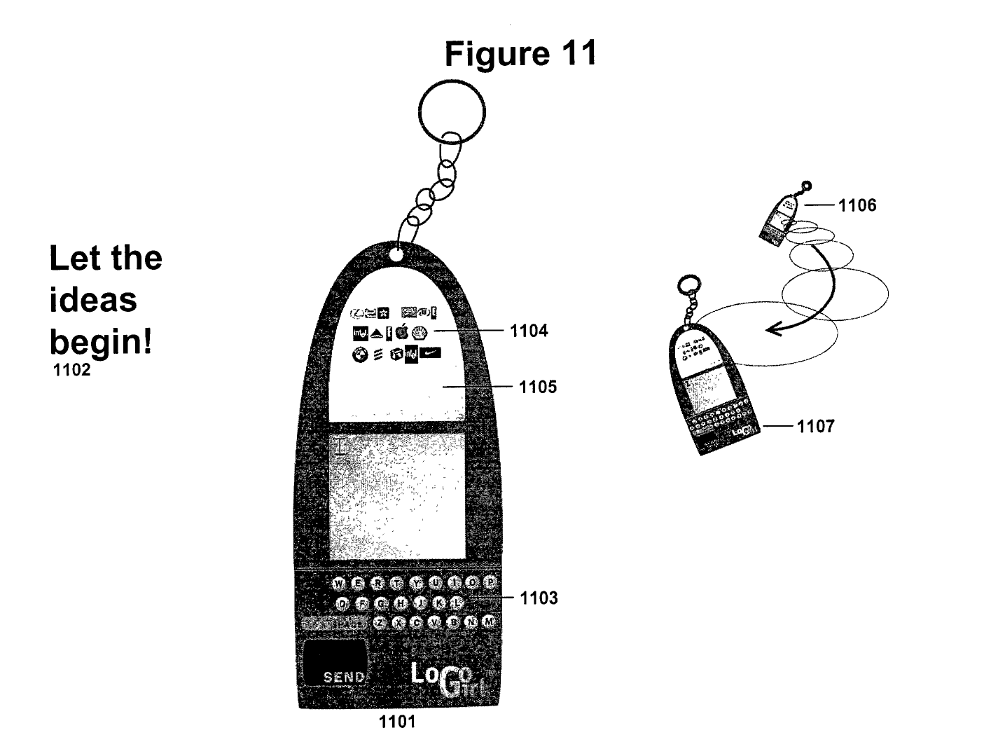

In an alternative embodiment depicted in FIG. 11, the apparatus 1101 according to the present invention is configured to receive or accept input of a message, associate one of a plurality of symbols with each message subset of the message, form a symbol message by replacing each message subset of the message with the one of the plurality of symbols associated with that message subset, and display the symbol message.

For example, in the embodiment depicted in FIG. 11, the message “LET THE IDEAS BEGIN” 1102 is input via keyboard 1103. In other embodiments, the input device could be a variety of other devices, e.g., a stylus, or a voice recognition device.

In the embodiment depicted in FIG. 11, apparatus 1101 associates symbols—in this example, registered trademark symbols associated with Lexus, Enterprise Rent-A-Car Co., Texaco, Inc., Toyota, Hilton Hotels Corp., E! Entertainment Television, Inc., Intel Corp., Delta Air Lines, Inc., Apple Computer, Inc., Shell Oil Co., BMW, Ericsson Corp., Gateway, Inc., and Nike, Inc.—with each message subset of the message. In this example, the message subsets are the letters forming the message. In other embodiments, the symbols and message subsets may take other forms, and various messages could be divided into various subsets, for example, by a user inputting the message or by the apparatus accepting the input of the message.

In the embodiment depicted in FIG. 11, apparatus 1101 then replaces each message subset with the associated symbol, uses the associated symbols to construct a symbol message 1104 corresponding to the message, and displays the corresponding symbol message 1104 on a display 1105.

In another embodiment, for example the apparatus 1106 depicted in FIG. 11, the apparatus has a transmitter (not depicted) and is configured to transmit symbol messages.

In yet another alternative embodiment, for example the apparatus 1107 depicted in FIG. 11, the apparatus has a receiver (not depicted) and is configured to receive transmission of a symbol message. In other embodiments, the apparatus is configured to display the received transmission of a symbol message.

In yet another embodiment, the apparatus is configured to decode a received transmission of a symbol messages into a text message. For example, in one embodiment, the apparatus is configured to associate one or more symbol message subsets of the received transmission of a symbol message with a text message subset, and then to display each associated text message subset.

More generally, available technology and information known in the art may be used to fabricate program and control components or devices capable of performing, or facilitating the performance of, the requisite tasks or steps for implementing the methods of the present invention. These components or devices include without limitation computers, computerized devices, cellular telephones, hand-held computerized devices, microprocessors, computerized devices, disk drives, floppy disks, CD-ROMs, CDs, and other computerized devices.

It will be apparent to those skilled in the art that various modifications can be made to this invention of methods and apparatus for generating symbol messages and grammar without departing from the scope or spirit of the invention or of the claims. It is also intended that the present invention and appended claims cover modifications, variations and equivalents of the methods and apparatus for generating symbol messages and grammar of the present invention.

What is claimed is:

1. An apparatus for generating a symbol-message, comprising
an input device configured to receive information;
a visual display;
a memory device configured to receive and store information;
a microprocessor in communication with the memory device, the input device, and the visual display;
a receiver configured to receive transmissions; and
a transmitter configured to send transmissions,
the apparatus configured to
a) receive input of a message comprising at least one message subset;
b) associate one of a plurality of symbols with each message subset of the message;
c) form a first symbol message by replacing each message subset of the message with the one of the plurality of symbols associated with that message subset; and
d) display the first symbol message,
wherein each of the plurality of symbols comprises a trademark, a registered trademark, a service mark, a registered service mark, or a well-known mark.

2. The apparatus of claim 1 wherein each message subset of the message comprises a alphanumeric character, a phoneme, a word, or an ideograph.

3. The apparatus of claim 1 further configured to transmit the first symbol message.

4. The apparatus of claim 3 further configured to receive transmission of a second symbol message.

5. The apparatus of claim 4 further configured to display the second symbol message.

6. The apparatus of claim 4 wherein the second symbol message comprises at least one second symbol message subset and the apparatus is further configured to associate each of the at least one second symbol message subset with a text message subset and to display each associated text message subset.
